(19) United States
(12) Patent Application Publication
(10) Pub. No.: US 2024/0427394 A1
(43) Pub. Date: Dec. 26, 2024

(54) Scalable Computer System with Redundant Power Supplies for Improved Fault Tolerance and Reliability

(71) Applicant: International Business Machines Corporation, Armonk, NY (US)

(72) Inventors: Chuan Li, Shanghai (CN); Gang Lyu, Shanghai (CN); Ming Zhi Xu, Beijing (CN); Tian Hui Chen, Shanghai (CN); Jun Yong Xu, Shanghai (CN); Kan Peng Lv, Shanghai (CN)

(21) Appl. No.: 18/341,580

(22) Filed: Jun. 26, 2023

(51) Int. Cl. G06F 1/26; G06F 1/30

(52) U.S. Cl. CPC G06F 1/263; G06F 1/30

(57) ABSTRACT

Scalable computer systems with redundant power supplies for improved fault tolerance and reliability are provided. The system includes a plurality of compute nodes, and includes a plurality of DC power supplies arranged in a ring configuration with the compute nodes. The first compute node is electrically connected to the last DC power supply. Each compute node is coupled to receive regulated DC voltages from two of the plurality of DC power supplies. The compute nodes may include processors, storage devices and/or memory devices.

### BACKGROUND

The present disclosure relates generally to a scalable computer system architecture, and more specifically to a scalable computer system with redundant power supplies.

Scalable, high-performance computer systems are often configured as multiple, interconnected compute nodes. A compute node can provide processor, storage or memory resources. In rack-mounted servers, multiple servers (e.g., compute nodes) may be interconnected to provide scalable, high performance processor or storage resources. Rack-mounted servers are commonly found in data centers which may have hundreds of racks. Each server is a computer designed to be installed in a framework called a rack. The rack may contain multiple mounting slots called bays, each designed to hold a computer secured in place.

### SUMMARY

Illustrative embodiments provide scalable computer systems with redundant power supplies for improved fault tolerance and reliability. The illustrative embodiments provide redundancy without the need for an increased number of power supplies. In one illustrative embodiment, a system comprises a plurality of compute nodes, and comprises a plurality of DC power supplies arranged in a ring configuration with the compute nodes. The first compute node is electrically connected to the last DC power supply. Each compute node is coupled to receive regulated DC voltages from two of the plurality of DC power supplies. The compute nodes may include processors, storage devices and/or memory devices. In another illustrative embodiment, a system comprises a plurality of compute nodes and a plurality of DC power supplies arranged in a hypercube configuration with the compute nodes. The compute nodes and the DC power supplies each form a vertice of the hyper cube. Each compute node is coupled to receive regulated DC voltages from M DC power supplies, where M is an integer.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 illustrates an example system in which illustrative embodiments may be implemented;

FIG. 2 illustrates a computer system with redundant power supplies;

FIG. 3 illustrates an example scenario in which two power supplies fail;

FIG. 4 illustrates an example scenario in which a single power supply fails;

FIGS. 5A, 5B and 6 illustrate example systems arranged in hypercube configurations; and

FIG. 7 illustrates an example scenario where multiple power supplies fail.

### DETAILED DESCRIPTION

Various aspects of the present disclosure are described by narrative text and block diagrams of computer systems.

A “computer” is a term used in the present disclosure to describe a machine that can be programmed to carry out sequences of arithmetic or logical operations. Modern digital computers can perform generic sets of operations known as programs. These programs enable computers to perform a wide range of tasks. A “computer system” is a term used in the present disclosure to describe a computer that includes hardware, operating system and peripheral equipment needed for full operation. This term may also refer to a group of computers that are linked and function together, such as a computer network or computer cluster. In the present disclosure, the terms “computers”, “computer systems’ and “compute nodes” are used interchangeably.

A “processor” or a “central processing unit” is a term used in the present disclosure to describe an integrated circuit which executes instructions of a computer program, such as arithmetic, logic, controls, and input/output (I/O) operations. A processor or a CPU controls the interpretation and execution of instructions. The processor of a laptop computer or a personal computer may consist of a single microprocessor, while the processor or CPU of a mainframe computer may consist of multiple processing devices.

A “storage device” or a “memory device” is a term used in the present disclosure to describe any tangible device that can retain and store instructions for use by a computer processor. Without limitation, the storage device or the memory device may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. In the present disclosure, the terms “storage device”, “memory device” and “storage nodes” are used interchangeably.

The illustrative embodiments recognize and take into account that in interconnected compute nodes, each compute node is generally connected to at least one dedicated DC power supply which is not shared among different compute nodes. Thus, if a dedicated power supply fails, only a single compute node associated with the power supply is affected. A DC power supply provides regulated DC voltages (e.g., 10V or 15V) to the compute nodes. In many implementations, the DC power supply can be configured as a switch-mode regulated DC to DC converter which converts a higher DC voltage (e.g., 20V, 30V or 45V) to a regulated lower DC voltage (e.g., 10V or 15V) which may be suitable for the compute node. In other implementations, the DC power supply may receive an AC input voltage (e.g., 120V, 220V). The AC input voltage is initially rectified to an unregulated DC voltage which is then converted to a regulated DC voltage.

The illustrative embodiments recognize and take into account that in existing interconnected compute nodes, for increased redundancy and reliability, each compute node is connected to more than one DC power supply. If one of the DC power supplies fails, the other DC power supply can continue to provide power to the compute node, thus allowing the compute to operate without interruption.

The illustrative embodiments also take into account that as the number of compute nodes increases, the number of DC power supplies also increases. For example, in rack-mounter servers, 20 or more server computers may be installed in a rack. Thus, for redundancy, at least 40 DC power supplies are required in each rack.

The illustrative embodiments provide a scalable computer system with redundant power supplies for improved fault tolerance and reliability. An advantage of the illustrative embodiments is that they provide redundancy without the need for an increased number of power supplies. Unlike existing architectures which generally require two dedicated power supplies for each compute node, in the illustrative embodiments, the number of power supplies and the number of compute nodes are equal. By reducing the total number of power supplies yet providing increased redundancy, the disclosed embodiments lower cost and complexity.

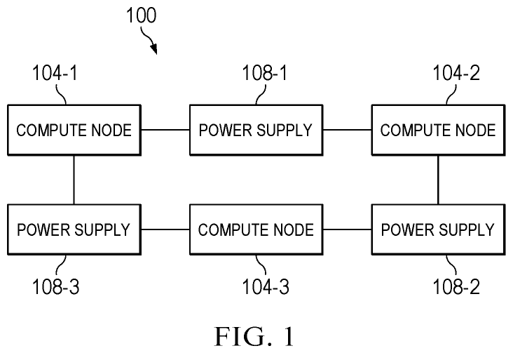

FIG. 1 illustrates an example system 100 that can implement aspects of a scalable computer system with redundant power supplies for improved fault tolerance and reliability. It should be appreciated that FIG. 1 is only meant as an example and is not intended to assert or imply any limitation with regard to the environments in which different embodiments may be implemented. Many modifications to the depicted environment are possible.

System 100 includes a plurality of compute nodes 104-1, 104-2, 104-3 and a plurality of DC power supplies 108-1, 108-2, 108-3 coupled in a ring configuration. A ring configuration is also referred to as a daisy chain wiring scheme in which multiple devices (e.g., compute nodes and power supplies) are wired together in a ring.

Each compute node is electrically connected to two power supplies. For example, compute node 104-1 is electrically connected to power supplies 108-1 and 108-3, and compute node 104-3 is electrically connected to power supplies 108-2 and 108-3. The first compute node (e.g., compute node 104-1) is electrically connected to the last power supply (e.g., 108-3), thus forming a ring or a daisy chain.

Although system 100 is depicted to include only three compute nodes (e.g., 104-1, 104-2 and 104-3) and three power supplies (e.g., 108-1, 108-2 and 108-3), it should be appreciated that system 100 can be configured to include a higher or a lower number of compute nodes and power supplies.

System 100 provides scalability because the number of compute nodes may be increased if necessary. Also, system 100 provides redundant power supplies for improved fault tolerance and redundancy because each compute node is coupled to receive regulated DC voltages from two power supplies. For example, compute node 104-2 receives DC voltages from power supplies 108-1 and 108-2. Thus, a failure of a single power supply cannot compromise any compute node.

In some example embodiments, computes nodes 104-1, 104-2 and 104-3 may include processors, storage devices and/or memory devices. In other embodiments, compute nodes 104-1, 104-2 and 104-3 may be storage nodes configured for data storage purposes. In some implementations, the power supplies 108-1, 108-2 and 108-3 may be switch-mode regulated DC to DC converters which convert a higher DC input voltage (e.g., 20V, 30V or 45V) to a regulated lower DC voltage (e.g., 5V or 12V) suitable for the compute nodes. In other implementations, the DC power supplies may receive an AC input voltage (e.g., 120V, 220V, 380V) which can be rectified to an unregulated DC voltage and is then converted to a regulated DC voltage.

An advantage of system 100 is that it provides redundancy without the need for an increased number of power supplies. Unlike existing architectures which generally require two dedicated power supplies for each compute node, in system 100 the number of power supplies and the number of compute nodes are equal. For example, in system 100 three power supplies 108-1, 108-2 and 108-3 are required for three compute nodes 104-1, 104-2 and 104-3. By reducing the total number of power supplies yet providing redundancy, system 100 lowers cost and complexity of a system comprising multiple compute nodes.

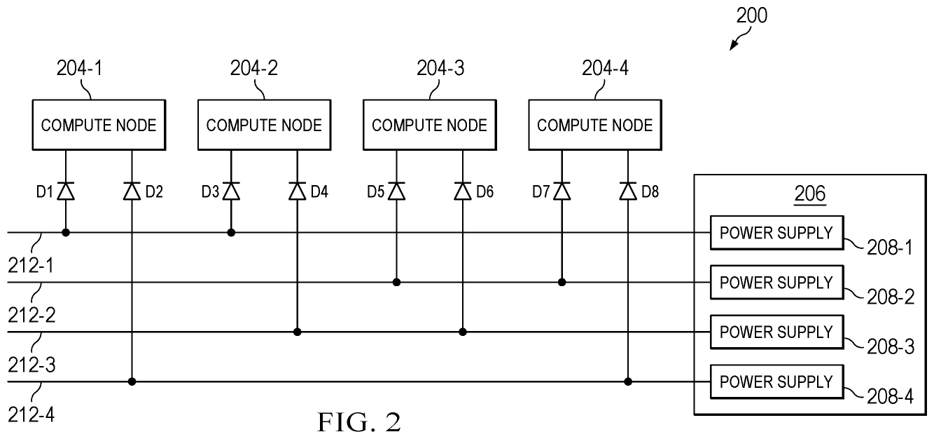

FIG. 2 illustrates an example system 200 that can implement aspects of a scalable computer system with redundant power supplies for improved fault tolerance and reliability. System 200 includes four compute nodes 204-1, 204-1, 204-3 and 204-4 coupled to four power supplies 208-1, 208-2, 208-3 and 208-4 in a ring configuration. Power supplies 208-1, 208-2, 208-3 and 208-4 are installed in a rack 206. The rack 206 might contain multiple mounting slots called bays (not shown), each designed to hold a power supply secured in place. Compute nodes 204-1, 204-2, 204-3 and 204-4 may also be installed in a rack (not shown in FIG. 2).

In an example embodiment, bus bars 212-1, 212-2, 212-3 and 212-4 are electrically connected to respective power supplies 208-1, 208-2, 208-3 and 208-4. Bus bars allow two compute nodes to electrically connect with a power supply. For example, compute nodes 204-1 and 204-2 are electrically connected to power supply 208-1 via bus bar 212-1, and compute nodes 204-3 and 204-4 are electrically connected to power supply 208-2 via bus bar 212-2.

In system 200, each power supply provides regulated DC voltage to two compute nodes. For example, power supply 208-3 provides regulated DC voltage to compute nodes 204-2 and 204-3, and power supply 208-4 provides regulated DC voltage to compute nodes 204-1 and 204-4.

In some example implementations, to prevent a failure of a power supply from compromising another power supply, compute nodes 204-1, 204-2, 204-3 and 204-4 are connected to the bus bars via diodes. For example, compute node 204-1 is connected to bus bars 212-1 and 212-4 via respective diodes D1 and D2. Diodes D1 and D2 have respective anodes connected to bus bars 212-1 and 212-4 and have respective cathodes connected to compute node 204-1. Likewise, compute node 204-2 is connected to bus bars 212-1 and 212-3 via respective diodes D3 and D4. Diodes D3 and D4 have respective anodes connected to bus bars 212-1 and 212-3 and have respective cathodes connected to compute node 204-2. The diodes allow current to flow unidirectionally from the anode to the cathode, thus preventing current from one power supply to flow into another power supply. If, for example, the output of power supply 208-1 is pulled to ground due to a fault condition, diodes D1 and D2 prevent the output of power supply 208-4 from also being pulled to ground.

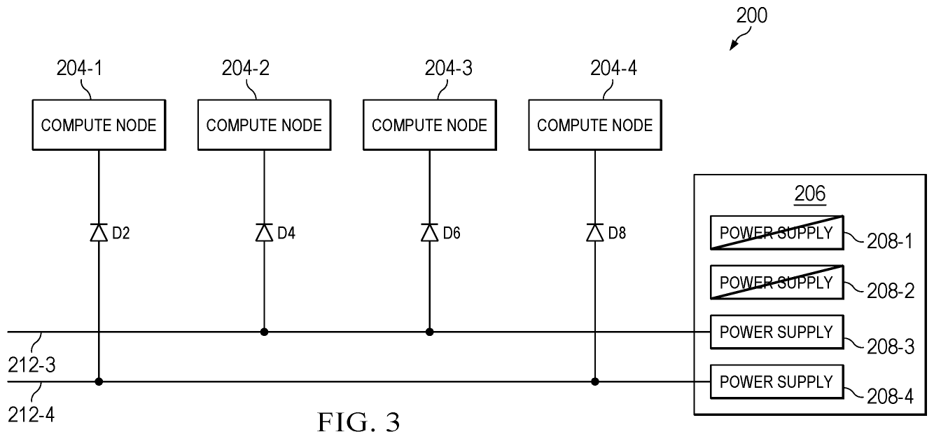

FIG. 3 illustrates an example event where power supplies 208-1 and 208-2 of system 200 fail and, thus, are unable to provide regulated DC voltages. Because of the redundancy of the architecture of system 200, power supplies 208-3 and 208-4 which are operational are still able to provide DC voltages to compute nodes 204-1, 204-2, 204-3 and 204-4. Thus, even in the case of a failure of two of four power supplies, compute nodes 204-1, 204-2, 204-3 and 204-4 can remain operational.

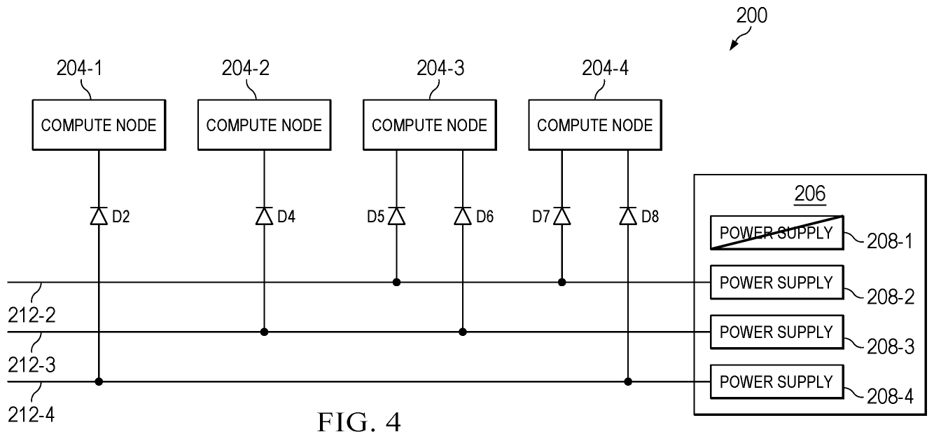

FIG. 4 illustrates an example event where only a single power supply (e.g., power supply 208-1) of system 200 fails. Because of the redundancy of the architecture, power supplies 208-2, 208-3 and 208-4 which are still operational are still able to provide DC voltages to compute nodes 204-1, 204-2, 204-3 and 204-4. In this example scenario, compute node 204-1 receives power from power supply 208-4, and compute node 204-2 receives power from power supply 208-3, while compute node 204-3 receives power from power supplies 208-2 and 208-3, and compute node 204-4 receives power from power supplies 208-2 and 208-4.

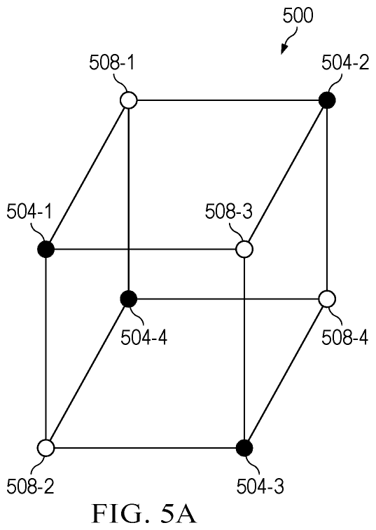

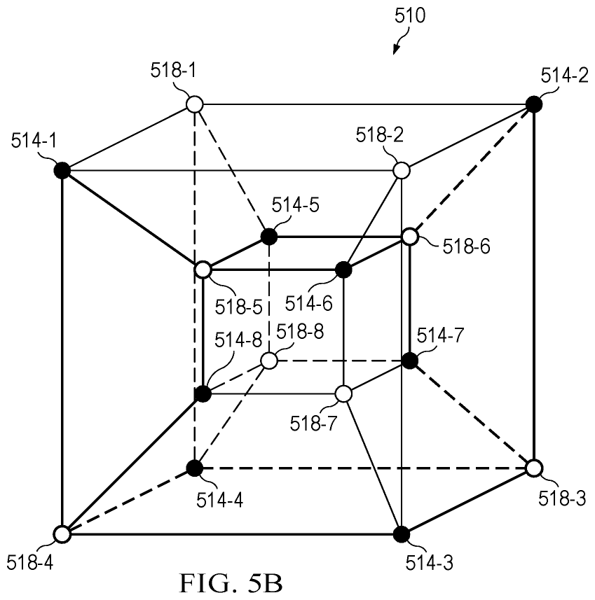

FIG. 5A illustrates an example system 500 in which a plurality of compute nodes 504-1, 504-2, 504-3 and 504-4 and a plurality of power supplies 508-1, 508-2, 508-3 and 508-4 are arranged in a hypercube configuration. Compute nodes 504-1, 504-2, 504-3 and 504-4 and power supplies 508-1, 508-2, 508-3 and 508-4 each form a vertice of the hypercube. The hypercube comprises 2^{M} vertices, where M is an integer. In system 500. M=3, and as such the hypercube has 8 vertices.

In system 500, each compute node is coupled to receive regulated DC voltages from 3 power supplies. For example, compute node 504-1 is coupled to receive DC voltages from power supplies 508-1, 508-2 and 508-3, and compute node 504-2 is coupled to receive DC voltages from power supplies 508-1, 508-3 and 508-4. Compute nodes 504-1, 504-2, 504-3 and 504-4 are not directly connected to each other, and power supplies 508-1, 508-2, 508-3 and 508-4 are not directly connected to each other. In some example embodiments, compute nodes 504-1, 504-2, 504-3 and 504-4 may include processors, storage devices and/or memory devices.

If power supplies 508-1 and 508-3 fail, compute node 504-1 can receive DC voltage from power supply 508-2 and continue to operate without interruption. Likewise, if power supplies 508-2 and 508-4 both fail, compute node 504-4 can receive DC voltage from power supply 508-1 and continue to operate without interruption. Thus, system 500 provides increased redundancy and fault tolerance because if one or even two power supplies fail, all four compute nodes may continue to operate without interruption.

In some example embodiments, compute nodes and power supplies can be arranged in a hypercube configuration which can have 16 or more vertices. In a hypercube with 16 vertices, 8 compute nodes and 8 power supplies each can form a vertice of the hypercube. FIG. 5B illustrates an example system 510 in which a plurality of compute nodes 514-1-514-8 and a plurality of power supplies 518-1-518-8 are arranged in a hypercube configuration which has 16 vertices.

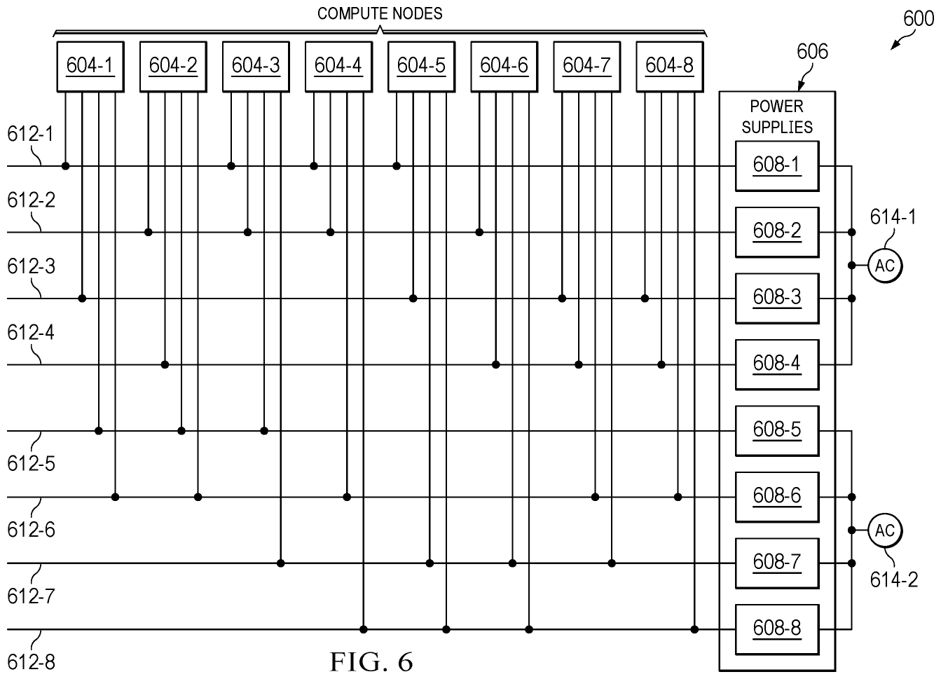

FIG. 6 illustrates an example system 600 in which 8 compute nodes 604-1-604-8 and 8 power supplies 608-1-608-8 are arranged in a hypercube architecture. Power supplies 608-1-608-8 are installed in power cages 606 (also referred to as a rack). Power cages 606 contains multiple mounting slots (not shown) called bays, each designed to hold a power supply secured in place. Compute nodes 604-1-604-8 may similarly be installed in cages or in a rack (not shown in FIG. 6). In system 600, each compute node is coupled to receive DC voltages from four power supplies.

In an example embodiment, bus bars 612-1, 612-2, 612-3, 612-4, 612-5, 612-6, 612-7 and 612-8 are electrically connected to respective power supplies 608-1, 608-2, 608-3, 608-4, 608-5, 608-6, 608-7 and 608-8. Bus bars allow each compute node to electrically connect with four power supplies. For example, compute node 604-1 is electrically connected to bus bars 612-1, 612-3, 612-5 and 612-6. As such, compute node 604-1 receives DC voltages from power supplies 608-1, 608-3, 608-5 and 608-6. Each power supply is electrically connected to four compute nodes. For example, power supply 608-1 is electrically connected to compute nodes 604-1, 604-3, 604-4 and 604-5. In some example embodiments, power supplies 608-1, 608-2, 608-3 and 608-4 are coupled to AC input source 614-1, and power supplies 608-5, 608-6, 608-7 and 608-8 are coupled to AC input source 614-2.

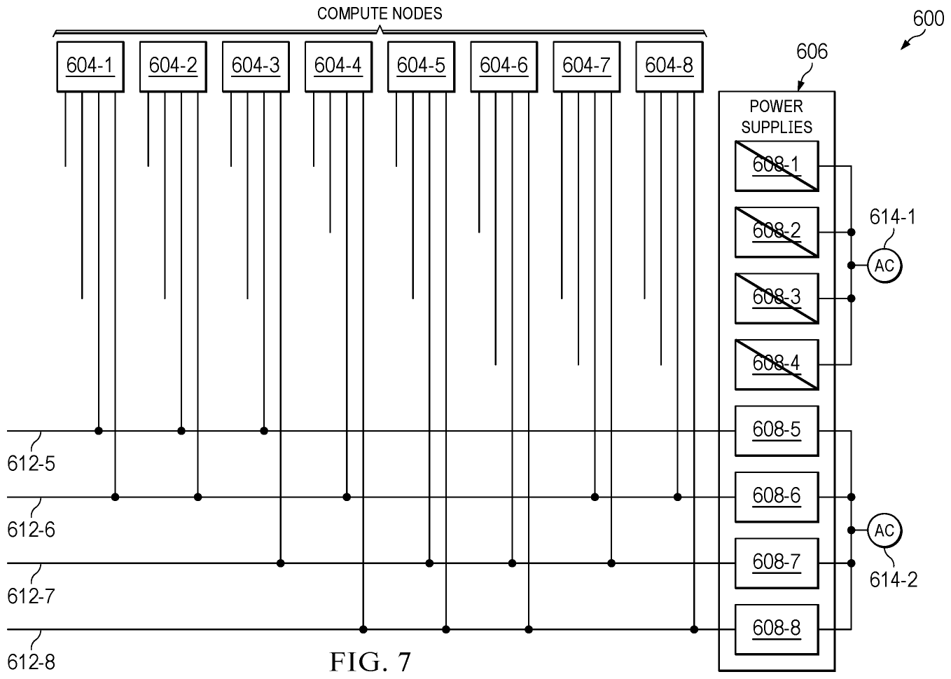

FIG. 7 illustrates an example scenario where power supplies 608-1, 608-2, 608-3 and 608-4 of system 600 fails and, thus, are unable to provide regulated DC voltages. This scenario is possible if AC input source 614-1 loses power. Because of the high level of redundancy of the architecture of system 600, power supplies 608-5, 608-6, 608-7 and 608-8 which are operational are able to provide DC voltages to all compute nodes. Notably, even in the event of a failure of four power supplies, each compute node continues to receive DC voltages from 2 power supplies. For example, compute node 604-3 receives DC voltages from power supplies 608-5 and 608-7, and compute node 604-4 receives DC voltages from power supplies 608-6 and 608-8.

Unlike existing architectures which generally require two dedicated power supplies for each compute node, in system 600 the number of power supplies and the number of compute nodes are equal. For example, in system 600 eight power supplies 608-1-608-8 are required for eight compute nodes 604-1-604-8. By reducing the total number of power supplies yet providing redundancy, system 600 lowers cost and complexity of a system having multiple compute nodes.

As used herein, a “number of,” when used with reference to objects, means one or more objects. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present disclosure have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A system comprising:
a plurality of compute nodes; and
a plurality of DC power supplies arranged in a ring configuration with the plurality of compute nodes, wherein a first compute node is electrically connected to a last DC power supply, and wherein each compute node is coupled to receive regulated DC voltages from two of the plurality of DC power supplies.

2. The system of claim 1, wherein the compute node is a processor.

3. The system of claim 1, wherein the compute node is a storage device.

4. The system of claim 1, wherein the compute node is a memory device.

5. The system of claim 1, wherein each DC power supply is coupled to provide regulated DC voltages to two of the plurality of compute nodes.

6. The system of claim 1, wherein each DC power supply is electrically connected to two of the compute nodes via diodes.

7. A system comprising:
a plurality of compute nodes; and
a plurality of DC power supplies arranged in a hypercube configuration with the plurality of compute nodes, wherein the plurality of compute nodes and the plurality of DC power supplies each form a vertice of the hypercube, and wherein each compute node is coupled to receive regulated DC voltages from M DC power supplies, wherein M is an integer.

8. The system of claim 7, wherein the hypercube comprises 2^{M} vertices.

9. The system of claim 7, wherein the compute node is a processor.

10. The system of claim 7, wherein the compute node is a storage device.

11. The system of claim 7, wherein the compute node is a memory device.

12. The system of claim 7, wherein each DC power supply is electrically connected to M compute nodes via diodes.

13. The system of claim 7, wherein each DC power supply is coupled to provide regulated DC voltages to M compute nodes.

14. A system comprising:
a plurality of compute nodes; and
a plurality of DC power supplies arranged in a hypercube configuration with the plurality of compute nodes, wherein the plurality of compute nodes and the DC power supplies each form a vertice of the hypercube comprising 2^{M} vertices, where M is an integer, wherein each compute node is coupled to receive regulated DC voltages from M DC power supplies, and wherein each DC power supply is electrically connected to M compute nodes via respective diodes.

15. The system of claim 14, wherein the compute node is a processor.

16. The system of claim 14, wherein the compute node is a storage device.

17. The system of claim 14, wherein the compute node is a memory device.

18. The system of claim 14, wherein each DC power supply is coupled to provide regulated DC voltages to M compute nodes.
